(19) United States
(12) Patent Application Publication
(10) Pub. No.: US 2026/0168612 A1
(43) Pub. Date: Jun. 18, 2026

(54) COMPRESSION MEMBER FOR A FLUID TRANSPORT PIPE PROVIDED WITH AN INTERNAL PROTECTIVE LINING

(71) Applicant: SAIPEM S.A., Montigny le Bretonneux (FR)

(72) Inventors: Raymond HALLOT, Voisins le Bretonneux (FR); Sébastien BLASSIAU, Montigny le Bretonneux (FR)

(21) Appl. No.: 18/707,947

(22) PCT Filed: Nov. 16, 2022
(86) PCT No.: PCT/FR2022/052100

§ 371 Date: May 7, 2024

(30) Foreign Application Priority Data
Nov. 19, 2021 (FR) FR21 12276

(51) Int. Cl. F16L 58/18; F16L 58/16

(52) U.S. Cl. CPC F16L 58/181; F16L 58/16

(57) ABSTRACT

A compression member for a fluid transport pipeline provided with an inner protective liner, includes an annular ring intended to be forcibly inserted inside the pipeline. The pushing end of the ring comprises an annular flange protruding radially outwards and forming a bearing surface for a tool pushing the ring inside the pipeline, an annular cavity formed upstream of the flange, and an annular element for filling the cavity, intended to be inserted inside the cavity of the ring, the filling element being an independent part of the ring which has a frustoconical shape so as to facilitate the passage of scrapers inside the pipeline once the filling element is inserted inside the cavity of the ring.

### TECHNICAL FIELD

The present invention relates to the general field of pipelines made by assembling steel pipeline elements and including an inner plastic liner protecting the steel walls of the pipelines from corrosion.

The present invention more specifically relates to pipelines conveying corrosive fluids, in particular subsea pipelines conveying pressurized seawater intended to be injected into oil field wells.

### PRIOR ART

Such subsea pipelines are generally made by butt welding of the ends of steel pipeline elements. The steels constituting the pipelines and the welds between pipeline elements may be subject to corrosion when the pipeline conveys a corrosive fluid, in particular water or a fluid including water, and more particularly salt water.

A known solution to overcome this problem consists in protecting the inner steel surface of the pipeline against corrosion by applying a liner made from a thermoplastic material flexible coating. However, the ends of the pipeline elements must not be pre-coated with this protective coating. Indeed, the latter does not withstand the high temperatures implemented during the operations of welding the pipeline elements together.

To ensure the continuity of the thermoplastic material protective coating at the ends of the two pipeline elements to be welded, it is known to insert a tubular junction sleeve made of anti-corrosion material into the pipeline, the sleeve sealingly overlapping the ends of the two protective coatings inside the pipeline and in line with the weld to be made. This type of solution thus makes it possible to avoid making an anti-corrosion alloy steel liner and/or an anti-corrosion alloy steel weld. On the other hand, these tubular junction sleeves have the drawback of being complex and expensive to set up.

It is also known from document WO 2020/053511 a solution to assemble the pipeline elements to be welded directly together with a peripheral weld made of anti-corrosion steel. A compression ring made of corrosion-resistant alloy steel is inserted inside the end portion of each pipeline element in order to ensure the protection and insulation of the end portion of the protective coating during the welding of the ends of the pipeline elements.

This solution thus makes it possible to ensure the protection against corrosion of the inner wall of the pipeline with a thermoplastic material protective coating on the current portion of the pipeline elements and a coating made of anti-corrosion steel at the ends to be welded of the two pipeline elements, and this without resorting to a tubular junction sleeve and/or without interposing a steel connection part of smaller dimension than the pipeline element to be welded between the two pipeline elements.

In this solution, the compression ring comprises a frustoconical end portion in order to create a gradual variation in the internal diameter of the pipeline at the level of the transition between the end portion of the unlined anti-corrosion alloy layer and the end portion of the plastic coating in extra thickness compared to the second end portion of the unlined anti-corrosion alloy layer.

However, such a compression ring has the drawback of being difficult to be forcibly inserted inside the pipeline since its frustoconical end portion does not offer sufficient bearing surface for a push tool (typically a hydraulic piston). A pushing tool specific to this type of compression ring must therefore be used.

### DISCLOSURE OF THE INVENTION

The aim of the invention is therefore to propose a compression member that can be easily inserted into the pipeline by a conventional pushing tool while facilitating the passage of scrapers inside the pipeline.

This aim is achieved thanks to a compression member for a fluid transport pipeline provided with an inner protective liner, comprising an annular ring intended to be forcibly inserted inside the pipeline and which comprises a downstream insertion end with a frustoconical shape, an upstream pushing end opposite to the insertion end, and a substantially cylindrical central portion connecting the upstream and downstream ends together and intended to compress one end of the inner protective liner against an inner wall of the pipeline, in which, in accordance with the invention, the pushing end comprises:
an annular flange protruding radially outwards and forming a bearing surface for a tool pushing the ring inside the pipeline;
an annular cavity formed upstream of the flange; and
an annular element for filling the cavity, intended to be inserted inside the cavity of the ring, the filling element being an independent part of the ring which has a frustoconical shape so as to facilitate the passage of scrapers inside the pipeline once the filling element is inserted inside the cavity of the ring.

The invention is remarkable in particular in that it proposes a compression member provided with both a straight bearing surface to allow the pushing tool to rest in order to forcibly insert the ring inside the pipeline, and a frustoconical shape allowing it to facilitate the passage of scrapers inside the pipeline.

Preferably, the cavity of the ring comprises, at an upstream end, a rim protruding inwards to ensure axial blocking of the filling element once it is inserted inside the cavity.

According to a first embodiment, the filling element is a frustoconical crown made of polymer material which is able to deform in order to be forcibly inserted into the cavity of the ring.

According to a second embodiment, the filling element is composed of a material injected into a frustoconical mold previously positioned around the cavity.

According to a third embodiment, the filling element is a frustoconical annulus made of polymer material and split so as to allow a reduction in its diameter during its forcible insertion into the cavity of the ring.

In this embodiment, the annulus can further comprise a snap ring housed in an annular groove so as to ensure retention of the annulus in the cavity of the ring 2.

Whatever the embodiment, the upstream end of the ring is advantageously welded to the inner wall of the pipeline.

In addition, the frustoconical shape of the insertion end of the ring is advantageously flared downstream and the frustoconical shape of the filling element is flared upstream.

The invention also relates to a method for mounting the compression member as defined above inside a fluid transport pipeline provided with an inner protective liner, comprising the forcible insertion of the ring inside the pipeline using a pushing tool bearing against the flange of the pushing end, the welding of an upstream end of the ring to an inner wall of the pipeline, and the insertion of the filling element inside the cavity of the ring.

In the case of an application to a compression member according to the first embodiment, the crown forming the filling element is advantageously deformed by heating prior to its insertion inside the cavity of the ring.

In the case of an application to a compression member according to the second embodiment, the step of inserting the filling element advantageously comprises the placement of the frustoconical mold around the cavity of the ring, the injection of a material into the mold to fill it, the cooling of the injected material, and the removal of the mold.

In this case, the material injected into the mold can be an epoxy resin, a polyurethane foam or a polyethylene foam.

In the case of an application to a compression member according to the third embodiment, the annulus forming the filling element is advantageously deformed by reduction of its diameter prior to its insertion inside the cavity of the ring.

### BRIEF DESCRIPTION OF THE DRAWINGS

FIG. 1 is a partial perspective view of a compression member according to a first embodiment of the invention.

FIGS. 2A to 2C are schematic views of different steps of mounting the compression member of FIG. 1.

FIGS. 3A to 3C represent steps of mounting a compression member according to a second embodiment of the invention.

FIG. 4 is a schematic perspective view of a compression member according to a third embodiment of the invention.

### DESCRIPTION OF THE EMBODIMENTS

The invention relates to a compression member intended to be inserted inside a pipeline for transporting corrosive fluids which is provided with an inner protective liner.

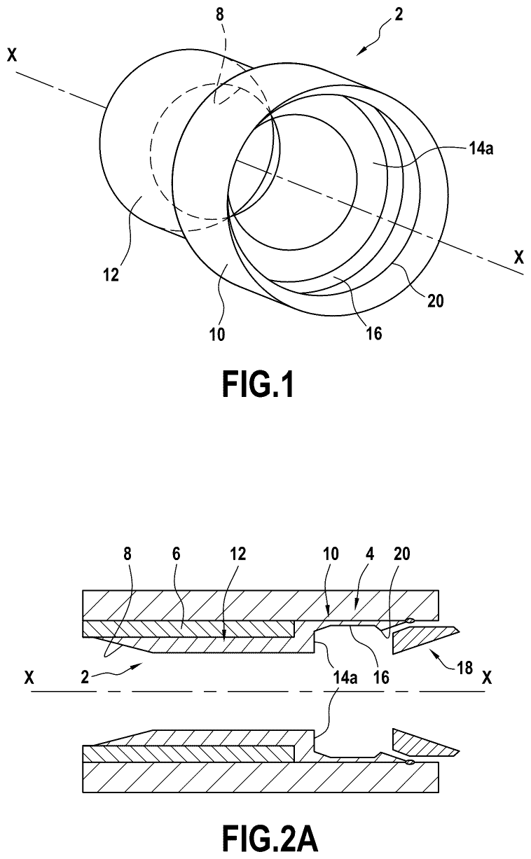

The compression member according to the invention consists of an annular ring as represented in FIG. 1, and of a filling element housed in a cavity of the ring.

FIG. 1 represents schematically and in perspective an annular ring 2 of a compression member according to a first embodiment of the invention.

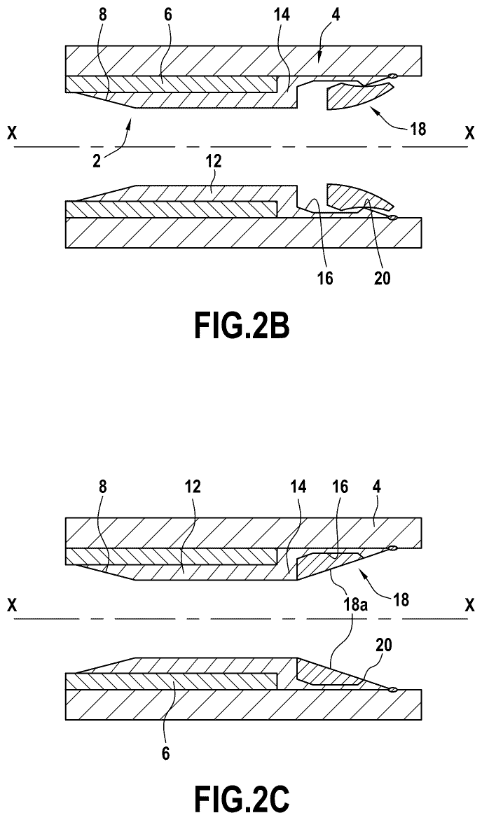

As represented in FIGS. 2A to 2C, this ring 2 is intended to be forcibly inserted inside a pipeline 4 for transporting corrosive fluids provided with an inner protective liner 6, made for example in a thermoplastic material.

The ring 2 has an axis of revolution X-X centered on the axis of the pipeline 4 when it is inserted inside the latter.

The ring 2 comprises a downstream insertion end 8 with a frustoconical shape, an upstream pushing end 10 opposite to the insertion end, and a substantially cylindrical central portion 12 connecting the downstream 8 and upstream 10 ends together.

The central portion 12 of the ring is intended to compress the end of the inner protective liner 6 against the inner wall of the pipeline 4.

In accordance with the invention, the pushing end 10 of the ring 2 comprises in particular an annular flange 14 which protrudes radially outwards. This flange 14 has a rear planar face 14a which extends along a radial direction (relative to the axis of revolution X-X of the ring) and which thus forms a bearing surface for a tool pushing the ring inside the pipeline.

The ring 2 pushing end 10 also comprises an annular cavity 16 which is formed upstream of the flange 14. As represented in FIG. 2A, this cavity 16 protrudes radially relative to the central portion 12 of the ring and bears directly against the inner wall of the pipeline.

The ring pushing end 10 also comprises an annular filling element 18 intended to be inserted inside the cavity 16.

This filling element 18 is an independent part of the ring 2 (it is in particular inserted into the pipeline after the ring has been inserted). It has a portion 18a with a frustoconical shape so as to facilitate the passage of scrapers inside the pipeline once it has been inserted inside the cavity of the ring.

Moreover, in order to ensure axial blocking of the filling element 18 once it is inserted inside the cavity 16 of the ring, the latter comprises at one upstream end a rim 20 protruding inwards.

Several embodiments of the filling element can be envisaged.

FIGS. 2A to 2C show a first of these embodiments. In this first embodiment, the filling element is a frustoconical crown 18 which is made of polymer material and which is able to deform to be forcibly inserted into the cavity 16 of the ring.

As represented in FIG. 2A, the ring 2 is first forcibly inserted inside the pipeline 4 via a pushing tool (not represented), typically a hydraulic piston, bearing against the bearing surface 14a of the flange 14 of the ring.

When the ring 2 is correctly positioned, the polymer material crown 18 is in turn inserted inside the pipeline 4 by means of another tool (not represented).

When the crown 18 reaches the rim 20 of the cavity of the ring (FIG. 2B), it is deformed locally in order to be able to overcome this obstacle and pass beyond it.

Once it has passed the rim 20, the crown returns to its initial shape and is housed inside the cavity 16 (FIG. 2C). Given its frustoconical portion 18a, the compression member thus has a frustoconical shape at its two longitudinal ends, thus making it possible to facilitate the passage of scrapers inside the pipeline (in both directions of advance).

It will be noted that to facilitate its local deformation and its insertion into the cavity of the ring, the crown 18 can advantageously be deformed by heating prior to its insertion inside the cavity of the ring. Once the crown is installed in the cavity and cooled, it returns to its initial rigidity.

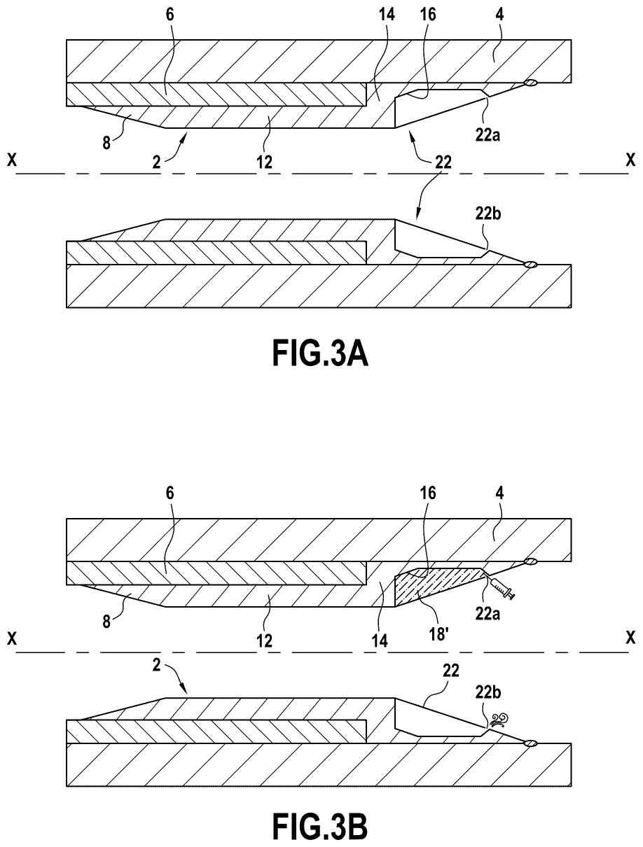

FIGS. 3A to 3C represent a second possible embodiment for the filling element.

In this embodiment, the filling element is composed of a material 18′ which is injected into a frustoconical mold 22 previously positioned around the cavity 16.

More specifically, once the ring 2 is correctly positioned inside the pipeline 4, a mold 22 having a frustoconical shape is inserted inside the pipeline to be positioned around the cavity to close it (FIG. 3A).

The mold 22 comprises at least one injection orifice 22a, and at least one air discharge orifice 22b.

The empty volume of the cavity 16 thus closed is then filled by the injection (via the injection orifice 22a) of resin materials such as epoxy, polyurethane foam or polyethylene foam (FIG. 3B). During the filling, the air is gradually replaced by the injected materials and escapes out of the cavity through the air discharge orifice 22b.

Once the volume of the cavity is completely filled with the injected materials, the mold is removed from the pipeline. The cavity 16 is then filled with a filling element 18′ and the compression member thus has a frustoconical shape at its two longitudinal ends (FIG. 3C).

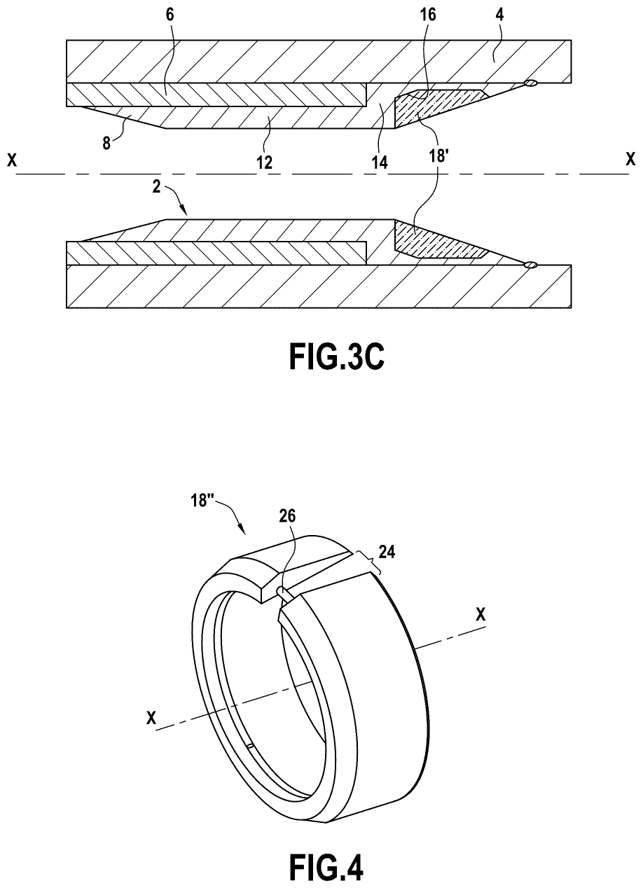

FIG. 4 represents a third possible embodiment for the filling element.

In this embodiment, the filling element is a frustoconical annulus 22″ which is made of polymer material and which is split so as to allow a reduction in its diameter during its forcible insertion into the cavity of the ring.

As represented in FIG. 4, the annulus 22″ has a slot 24 which allows slightly reducing its diameter in order to facilitate its forcible insertion inside the cavity of the ring.

Once the ring 2 is correctly positioned inside the pipeline 4, the annulus 22″ is deformed by reduction of its diameter to facilitate its insertion inside the cavity of the ring. When the annulus is correctly positioned inside the cavity, the deformation stops and it returns to its initial diameter.

Advantageously, the annulus 22″ further comprises a snap ring 26 (circlip type) housed in an annular groove so as to ensure retention of the annulus in the cavity of the ring 2.

It will be noted that whatever the embodiment of the compression member, the upstream end 10 of the ring 2 is preferably welded to the inner wall of the pipeline.

It will also be noted that the frustoconical shape of the ring 2 insertion end 8 is flared downstream, while the frustoconical shape of the filling element 18, 18′, 18″ is flared upstream.

1-13. (canceled)

14. A compression member for a fluid transport pipeline provided with an inner protective liner, comprising an annular ring intended to be forcibly inserted inside the pipeline and which comprises a downstream insertion end with a frustoconical shape, an upstream pushing end opposite to the insertion end, and a substantially cylindrical central portion connecting the upstream and downstream ends together and intended to compress one end of the inner protective liner against an inner wall of the pipeline,
wherein the pushing end comprises:
an annular flange protruding radially outwards and forming a bearing surface for a tool pushing the ring inside the pipeline;
an annular cavity formed upstream of the flange; and
an annular element for filling the cavity, intended to be inserted inside the cavity of the ring, the filling element being an independent part of the ring which has a frustoconical shape so as to facilitate the passage of scrapers inside the pipeline once the filling element is inserted inside the cavity of the ring.

15. The member according to claim 14, wherein the cavity of the ring comprises, at an upstream end, a rim protruding inwards to ensure axial blocking of the filling element once it is inserted inside the cavity.

16. The member according to claim 14, wherein the filling element is a frustoconical crown made of polymer material which is able to deform in order to be forcibly inserted into the cavity of the ring.

17. The member according to claim 14, wherein the filling element is composed of a material injected into a frustoconical mold previously positioned around the cavity of the ring.

18. The member according to claim 14, wherein the filling element is a frustoconical annulus made of polymer material and split so as to allow a reduction in its diameter during its forcible insertion into the cavity of the ring.

19. The member according to claim 18, wherein the annulus further comprises a snap ring housed in an annular groove so as to ensure retention of the annulus in the cavity of the ring.

20. The member according to claim 14, wherein the upstream end of the ring is welded to the inner wall of the pipeline.

21. The member according to claim 14, wherein the frustoconical shape of the insertion end of the ring is flared downstream and the frustoconical shape of the filling element is flared upstream.

22. A method for mounting the compression member according to claim 14 inside a fluid transport pipeline provided with an inner protective liner, comprising the forcible insertion of the ring inside the pipeline using a pushing tool bearing against the flange of the pushing end, the welding of an upstream end of the ring on an inner wall of the pipeline, and the insertion of the filling element inside the cavity of the ring.

23. The method according to claim 22, wherein the filling element is a frustoconical crown made of polymer material which is able to deform in order to be forcibly inserted into the cavity of the ring, wherein the crown forming the filling element is deformed by heating prior to its insertion inside the cavity of the ring.

24. The method according to claim 22, wherein the filling element is composed of a material injected into a frustoconical mold previously positioned around the cavity of the ring, wherein the step of inserting the filling element comprises the placement of the frustoconical mold around the cavity of the ring, the injection of a material into the mold to fill it, the cooling of the injected material, and the removal of the mold.

25. The method according to claim 24, wherein the material injected into the mold is an epoxy resin, a polyurethane foam or a polyethylene foam.

26. The method according to claim 22, wherein the filling element is a frustoconical annulus made of polymer material and split so as to allow a reduction in its diameter during its forcible insertion into the cavity of the ring, wherein the annulus forming the filling element is deformed by reduction of its diameter prior to its insertion inside the cavity of the ring.
